(19) United States
(12) Patent Application Publication
(10) Pub. No.: US 2015/0294279 A1
(43) Pub. Date: Oct. 15, 2015

(54) It will allow people to transfer money, goods, and services all over the world using a secure website that will connect all parties.

(71) Applicant: Climaco Chevalier, Cambria Heights, NY (US)

(72) Inventor: Climaco Chevalier, Cambria Heights, NY (US)

(73) Assignee: Climaco Chevalier, Cambria Heights, NY (US)

(21) Appl. No.: 14/682,101

(22) Filed: Apr. 9, 2015

Related U.S. Application Data
(60) Provisional application No. 61/977,485, filed on Apr. 9, 2014.

(51) Int. Cl. G06Q 20/10

(52) U.S. Cl. CPC G06Q 20/10

(57) ABSTRACT

My invention will allow people to transfer money, goods and services all over the world using a secure website. This service will allow people to meet face to face to give and collect funds, goods or services as soon as they desire and it will eliminate currency issues. With our live chat, people will be able to see who they are trading with on a computer, smart phone or tablet. The translating capability on the website will eliminate any language barriers so that everybody will understand each other regardless of their location or language. Both parties will be able to track each other's where about any way that they choose to. If one party is not happy with the other party they can find hundreds of other parties willing to trade in the same state or country.

### EXAMPLE

### Eliminating Currency Issue

If an individual living abroad needs to collect rent from a property located in an area other than where that individual resides. The individual will be able to log onto our website and locate other individuals in that area that is in need of funds relative to what he has to collect. There is no need to exchange currency because the currency stays local.

If the party (A) needs to transfer rent collected for the landlord (party B) residing in New York for a property in Haiti in American Dollars the money that party B is requesting to be delivered to his sister in Haiti was already in American Dollars. There is no need to exchange or buy currencies since it was already acquired in American dollars and it was going to be transferred or swapped locally the money stays the same. If it is collected in Haitian currency, party B in New York only has to give to party (A's) relative what the currency equal amount is at that specific time in Haiti.

### EXAMPLE

### Trading Funds.

Person A in New York needs to send $200 to his sister (person B) in Puerto Rico. He (person A) will sign up on our website and will find thousands people in Puerto Rico (person C) who also want to send the same amount of money to someone in New York (person D). He (person A) will locate the person (person C) that is closest to his sister's location. These two individual (person B and C) will meet and trade the equal amount of money within the same country/state/city or even borough.

This is a fast and simple way of trading; the individuals can decide details of the meeting since both parties will have one another's information. This system will allow every party involved to stay connected during the transaction via phone, text, and email and/or live on our website. Both parties will benefit from a safe and fast service. The money/goods/services never technically leave the country/state or even borough therefore eliminating any additional fees. Our job is to find the people in need of our services and connect them with one another so that they can trade funds, goods or services fast, safely, conveniently, any time at a low fee.

The invention does not collect or ship funds. It is left up to the parties as to how and where they decide to make the transaction possible. My job is to find the people in need of the services and connect them so they could trade funds, goods, or services safely. Big and small companies will benefit from this invention, and the same connection will allow transfers among companies by exchanging funds, goods or services from among each other or within their clients worldwide.

### EXAMPLE

### Urgent Medication Needs.

Even in the medical field, the invention will help save lives. A person with a serious illness will have access to any medication using the same system. For example, Mary resides in France while her brother, Paul, who is very ill and needs specific medication, resides in London. Even though it is in a different country and the medication could be under a different name, my invention will allow Mary to locate the proper medication for his brother on time before Paul falls into a more severe medical condition. The medication can buy Paul time to get to his own medication.

Somebody suffering from high blood pressure is in a remote part of the world or in a country where there isn't a nearby pharmacy available or a doctor to write a prescription. The patient's case gets critical and the medication is highly necessary. My invention will make it possible for the patient, or family member to locate another person with the same illness to deliver some of or the amount of medication they have to spare. In other words, the invention will help save lives; the capabilities are endless.

### EXAMPLE

### Using Assets Instead of Cash.

The invention will also make it possible for two people living in opposite side of the world to experience driving the same kind of car that they own or even a different car while vacationing. Let us say that Peter lives in Los Angeles and is going on vacation to New York but enjoys driving his 2012, 360 Ferrari. Around the same time (or even at a different time) Robert residing in New York is going to Los Angeles for a business trip. Robert owns a 360 Ferrari or even a Porsche but would enjoy driving a 360 Ferrari in Los Angeles. With my invention, both parties can connect via the site where they could discuss and show live video feed of their cars and once Peter gets to New York he could drive Robert's 2012 360 Ferrari at the same time (or at a different time), and Robert could drive Peter's 2012 360 Ferrari or a different car that Peter owns. Without having to ship or spend any money on a rental, both parties could respectfully enjoy the vehicle of their choice.

The same principle could be use for real estate. Paul who is living in Los Angeles is going to New York on vacation and would like to stay in the city, let us say, near Time Square. Robert who is going to Los Angeles for his business trip finds Peter's residence near the airport or maybe very close to where his business meeting is taking place. Both parties, Paul and Robert could log on and come up with an agreement and both parties could enjoy their stay and get what they want without sacrificing their savings. If a person owns more than one home, they could also chose or find somebody with a property where they could enjoy their stay.

The invention will also make it possible to satisfy some people with their love life, or even for a good company. We can use the same example where Paul's vacation to New York would enjoy the company of Roberts' family members, and Robert, on his business trip to Los Angeles, would like to be accompanied by Paul's sister, girlfriend, brother or mother. They could connect to our site and decide to choose with whom they want to spend their time without having to acquire for the service elsewhere from a stranger. All parties will be connected via our live video feed or live chat. They will already know each other and that will make things easier or safer considering that they have each other's information. It will make it very safe compare to a sites where you don't know the other personal identity since even when a picture is available, it doesn't necessary prove that it belongs to that person.

Another part of the invention will allow live sale or trade 24/7 between consumers to purchase goods or trade at real time. Video and chat will make it possible to shop and have direct secure live video feed between both parties. Users will be able to examine goods capable of seeing live models with their favorite items.

### EXAMPLE

### Security.

The alarm systems currently available are susceptible to flaws and large burglaries. In other words, when an alarm system is triggered, it only takes a code to deactivate the alarm, and the person deactivating it can be anyone who happens to know that alarm code. My invention, on the other hand, will make any alarm system user friendly to the user of my invention by allowing him or her and the alarm system company to interact with one other. No more false alarms. The user will be able to identify himself/herself by interacting with the alarm company. When the alarm is triggered, the user can have all videos at the location on auto, and this will automatically start transmitting live images to the alarm company of the user's residence or business with the information stored in the alarm company's database. It will help identify the user via face and voice recognition, as well as live video chat. This will also eliminate number codes that most of us do not remember and that can be used by someone who got access to the number codes at some point. For verifications purposes, when the alarm goes off, the alarm company will interrogate the person who enters the house as a potential criminal. My invention will put the person who entered the house, whether it is the customer or the intruder, face to face with the alarm company where they could communicate to verify their identity. I guarantee you that the intruder couldn't possibly get around this process of identification and will not stick around to respond to the questions.

1. I claim that my invention is an improvement to what currently exists: It will put the power on the consumer's hands. Consumers will connect with one another anywhere around the world regardless of their native language. This is a powerful way to connect them on a different platform where they could help each other by delivering funds, goods or services where necessary. Two individuals in need of similar services can help each other out in delivering funds, goods or services to there loved ones. Both parties control the transaction equally and there is no need to use a middleman or bank.
With the invention;
It is a safe way to save time and money.
It is accessible worldwide.
It is available in all languages.
It is available for a small monthly fee, no matter how many times you use it.
It is available 24 hours a day all year round instead of depending on banks or facilities limited hours.
There is no limit on the amount of funds, goods or services necessary to transfer and no additional cost for each party involved. Regularly, the fees for international shipping are astronomical because they are based on volume and weight. If it gets delivered locally from one consumer to the next it eliminates the big cost of shipment on the weight or volume of goods.
The most important part is that there will be a secure site capable of connecting the people looking for these services. Marketing will be an important factor in getting consumers to subscribe to the website. It will be available around the world in different languages to connect with people. As the company grows, we will make changes to tailor to the consumer's needs.
I claim that my invention will allow for endless possibilities, including eliminating currency issue, assisting with urgent medical needs, putting people's own personal assets to good use, and eliminating the middleman. The following are just a few scenarios of how my invention can be put into work.
